(19) United States
(12) Patent Application Publication
(10) Pub. No.: US 2007/0048604 A1
(43) Pub. Date: Mar. 1, 2007

(54) Lithium microbattery provided with a protective envelope, and method for producing one such microbattery

(75) Inventors: Frederic Gaillard, Voiron (FR); Marc Plissonnier, Eybens (FR); Raphael Salot, Lans En Vercors (FR); Stephanie Roche, Grenoble (FR)

Correspondence Address: OLIFF & BERRIDGE, PLC, P.O. BOX 19928, ALEXANDRIA, VA, 22320, US

(73) Assignee: Commissariat a L'Energie Atomique, Paris (FR)

(21) Appl. No.: 10/577,242

(22) PCT Filed: Nov. 4, 2004
(86) PCT No.: PCT/FR04/02841

§ 371 Date: Apr. 26, 2006

(30) Foreign Application Priority Data
Nov. 14, 2003 (FR) 0313324

(51) Int. Cl. H01M 2/02; H01M 2/04; H01M 10/04

(52) U.S. Cl. 429/175; 429/176; 429/231.95; 29/623.5

(57) ABSTRACT

A lithium microbattery comprises a substrate on which at least one stack is arranged successively comprising a cathode, an electrolyte containing lithium and an anode consisting of metallic lithium. A protective envelope comprising at least first and second distinct superposed layers covers the stack to protect the same against external contamination. The first layer, deposited on the whole of the anode, comprises at least one material that is chemically inert with regard to lithium, selected from the group consisting of a hydrogenated amorphous silicon carbide, a hydrogenated amorphous silicon oxycarbide, hydrogenated amorphous carbon, fluorinated amorphous carbon and hydrogenated amorphous silicon. The second layer comprises a material selected from the group consisting of a hydrogenated amorphous silicon carbonitride, a hydrogenated amorphous silicon nitride and a fluorinated amorphous carbon.

### BACKGROUND OF THE INVENTION

The invention relates to a lithium microbattery comprising a substrate on which at least one stack is arranged, said stack successively comprising a cathode, an electrolyte containing lithium and an anode made of metallic lithium, a protective envelope comprising at least first and second distinct superposed layers covering the stack to protect same against any external contamination.

The invention also relates to a method for producing one such lithium microbattery consisting in successively depositing on a substrate:

at least one stack comprising a cathode, an electrolyte comprising lithium and an anode made of metallic lithium

and a protective envelope comprising at least first and second distinct superposed layers covering the stack to protect same against external contamination.

### STATE OF THE ART

Penetration of oxygen, nitrogen, carbon dioxide and humidity into microbatteries comprising a metallic lithium anode and a lithiated compound-based electrolyte is known to be harmful to operation of the batteries. To prevent the lithiated elements of the lithium microbattery and especially the lithium of the anode from being in contact with the outside environment, it is known to arrange one or more protective layers on the microbattery so as to encapsulate the latter and protect it from gases and humidity.

For example, the document WO-A1-0247187 describes a lithium battery comprising a substrate on which there are successively arranged a current collector, a cathode, an electrolyte, an anode, a current collector totally covering the anode and a protective envelope in particular against heat. The protective envelope is formed by depositing two superposed thin layers on the whole of the current collector. Thermal annealing is performed at about 210° C. before a layer of epoxy resin is deposited on the whole of the stack and before an exposure by ultraviolet radiation and an annealing of the resin at about 260° C. are performed. The two thin layers are made from dielectric materials such as alumina, silica, silicon nitride, silicon carbide, or tantalum oxide, these materials being deposited by sputtering. The two layers can also be made of diamond or Diamond Like Carbon (DLC) and are preferably deposited by Plasma Enhanced Chemical Vapour Deposition (PECVD). Such an envelope protects the battery against heat, gases and liquids, but production thereof is long and fastidious and requires two annealings at temperatures of more than 200° C. Annealings at temperatures of more than 200° C. are however only acceptable for batteries comprising an anode made from lithiated materials. They can in fact not be used with a lithium anode which could be damaged at temperatures of more than 200° C.

To avoid annealings at high temperatures, the document U.S. Pat. No. 5,561,004 proposes covering the lithium anode with a shield being able to be formed by a layer or a combination of layers of ceramic, metal or parylene®. These materials do however have a hardness and a thickness that do not enable the battery to be put under pressure when encapsulation thereof is performed.

### OBJECT OF THE INVENTION

It is an object of the invention to provide a lithium microbattery comprising a protective envelope remedying the shortcomings set out above and in particular enabling the lithium microbattery to be produced on substrates comprising integrated circuits and preferably with a known technological process.

According to the invention, this object is achieved by the fact that the first layer, deposited on the whole of the anode, comprises at least one material that is chemically inert with regard to lithium, chosen from a hydrogenated amorphous silicon carbide, a hydrogenated amorphous silicon oxycarbide, hydrogenated amorphous carbon, fluorinated amorphous carbon and hydrogenated amorphous silicon, the second layer comprising a material chosen from a hydrogenated amorphous silicon carbonitride or a hydrogenated amorphous silicon nitride.

According to a development of the invention, an intermediate layer is arranged between the first and second layers, said intermediate layer comprising a material chosen from a phosphorus-doped silicon oxide, hydrogenated amorphous carbon and fluorinated amorphous carbon.

According to a preferred embodiment, the first and second layers forming an elementary stack, the protective envelope comprises a superposition of at least two elementary stacks.

It is a further object of the invention to provide a method for producing one such microbattery that is easy to implement and compatible with microelectronics technologies.

According to the invention, the method consists in successively depositing the first and second layers on the whole of the anode, by plasma enhanced chemical vapor deposition at a deposition temperature less than or equal to 150° C.

According to a development of the invention, the method consists in depositing an intermediate layer by plasma enhanced chemical vapor deposition at a deposition temperature less than or equal to 150° C., before deposition of the second layer, said intermediate layer comprising a material chosen from a phosphorus-doped silicon oxide, hydrogenated amorphous carbon and fluorinated amorphous carbon.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 is a schematic representation of a particular embodiment of a microbattery according to the invention, in cross-section.

FIGS. 2 to 5 schematically represent alternative embodiments of a microbattery according to the invention, in cross-section.

### DESCRIPTION OF PARTICULAR EMBODIMENTS

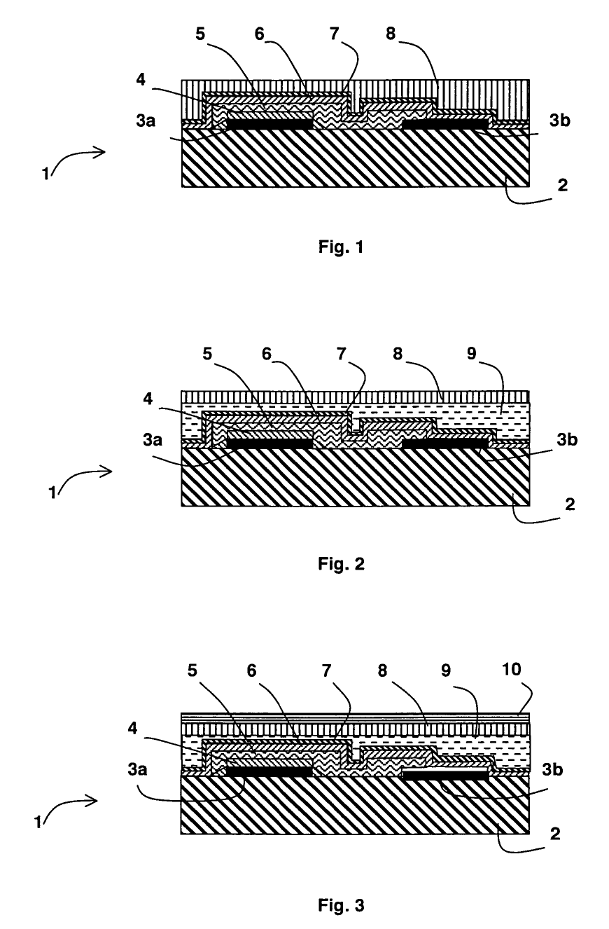

As represented in FIG. 1, a lithium microbattery 1 comprises a substrate 2 on which there are successively arranged, in the form of thin layers:

first and second current collectors 3a and 3b, the first current collector 3a being totally covered by a cathode 4,

an electrolyte 5 comprising a lithiated compound such as lithium and phosphorus oxynitride, better known under the name of LiPON, the electrolyte 5 being deposited such as to cover the cathode 4, the part of the substrate 2 separating the first and second current collectors 3a and 3b and a part of the second collector 3b,

an anode 6 made of metallic lithium such as to be in contact with the substrate 2, the electrolyte 5 and the free part of the second current collector 3b.

The cathode 4, electrolyte 5 and anode 6 form a stack called Electrode-Membrane-Electrode or “EME”. To protect this stack, and more particularly the metallic lithium anode 6, against any external contamination and especially against the gases contained in the air and against humidity, a protective envelope comprising at least first and second distinct superposed layers 7 and 8 is deposited on the whole of the anode 4 so as to totally cover the stack by forming an encapsulation. The first layer 7 is thus deposited on the whole of the anode 6 and is then covered by the second layer 8. The first and second layers 7 and 8 have a mean thickness of about one micrometer.

The first layer 7 comprises at least one material that is chemically inert with regard to lithium in order not to damage the anode 6. Thus, the material of the first layer 7 is chosen from:

a hydrogenated amorphous silicon carbide having a general formula SiCₓH_{z} with 0<x<1 or SiC:H,

a hydrogenated amorphous silicon oxycarbide having a general formula SiOₓC_{y}H_{z} or SiOₓC_{y}:H with 0<x<2 and 0<y<1,

hydrogenated amorphous carbon of general formula CH, or C:H,

fluorinated amorphous carbon of general formula CF, or C:F,

and hydrogenated amorphous silicon of general formula SiH_{z} or Si:H.

The first and second layers being distinct, the second layer comprises a material chosen from a hydrogenated amorphous silicon carbonitride of general formula SiCₓN_{y}H_{z} or SiCₓN_{y}:H with 0<x≦1 and 0<y≦1.33, a hydrogenated amorphous silicon nitride of general formula SiNₓH_{z} or SiNₓ:H with 0<x≦1.33 and a fluorinated amorphous carbon of general formula CFₓ with 0<x≦2 or C:F. Thus, when the second layer comprises fluorinated amorphous carbon, the first layer preferably comprises a material chosen from SiCₓH_{z} with 0<x<1, SiOₓC_{y}H_{z} with 0<x<2 and 0<y<1, CH_{z} and SiH_{z} whereas when the first layer comprises hydrogenated amorphous carbon, the second layer preferably comprises a material chosen from SiCₓN_{y}H_{z} with 0<x≦1 and 0<y≦1.33 and SiNₓH_{z} or SiNₓ:H with 0<x≦1.33.

What is meant by a hydrogenated element E, generally noted EH_{z} or E:H, or a fluorinated element E′ generally noted E′F_{z} or E′:F is that, when deposition of a thin layer of element E or E′ is performed, a proportion z of hydrogen or fluorine emanating from a precursor gas containing the hydrogen or fluorine bonds with the element E or E′ so as to form an amorphous element E or E′ comprising hydrogen or fluorine.

Such a protective envelope acts as a barrier between the anode 6 and the outside atmosphere so as to isolate the anode 6 from the gases in the air such as nitrogen, oxygen and carbon dioxide, and also from humidity. As the first layer is directly in contact with the anode 6, it is chemically and physically inert with regard to the lithium of the anode, which enables the anode 6 not to be damaged, and it is impermeable to gases. In addition, as the second layer 7 comprises nitrogen, it is impermeable to humidity. Finally, the first and second layers 7 and 8 present very good mechanical performances such as their hardness, which is greater than 2 GPa whereas spin-coated polymers have a hardness of less than 1 Gpa, and their elasticity, enabling very thin layers to be deposited without them cracking. Such a hardness in particular enables the microbattery to be put under pressure without being damaged and makes enables techniques that are commonly used in the microelectronics field to be implemented.

The lithium microbattery 1, as represented in FIG. 1, is therefore preferably produced by successively depositing the first and second layers on the whole of the anode 6, by Plasma Enhanced Chemical Vapor Deposition (PECVD) at a deposition temperature less than or equal to 150° C. The EME stack and the current collectors can be produced by a Physical Vapor Deposition (PVD) method or by spraying at low temperature. Thus, performing deposition of thin layers at low temperature enables the lithium microbattery and the substrate on which it is arranged not to be damaged. Thanks to this type of low-temperature deposition, it is then possible for example to integrate the lithium microbatteries inexpensively on substrates comprising integrated circuits, without having to stick them and while preserving the quality of the integrated circuits.

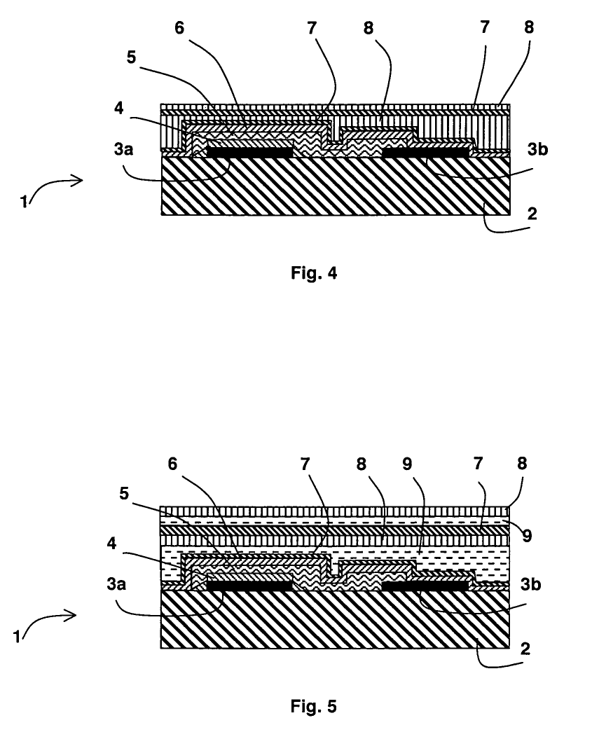

In a first alternative embodiment designed to increase the efficiency of the protective envelope, an intermediate layer 9, distinct from the first and second layers, can be arranged between the first and second layers 7 and 8, as represented in FIG. 2. It comprises a material chosen from a phosphorus-doped silicon oxide in a proportion that is preferably less than or equal to 10% in weight of the hydrogenated amorphous carbon and of the fluorinated amorphous carbon. The phosphorus doping the silicon oxide increases the protection performances of the first and second layers 7 and 8 by trapping the sodium or potassium type mobile charges. The intermediate layer 9 can also be achieved by PECVD at a deposition temperature less than or equal to 150° C., before deposition of the second layer. The intermediate layer 9 preferably has a mean thickness of about one micrometer.

The lithium microbattery 1 can also comprise a final layer of hydrogenated amorphous carbon or of fluorinated amorphous carbon, covering the second layer 7 of the protective envelope, the final layer being distinct from the second layer 7. Thus, in FIG. 3, a lithium microbattery 1 such as the one represented in FIG. 2 comprises a final layer 10 arranged on the second layer 7. The final layer 10 presents a very great hydrophobic characteristic, which enhances the thermal shield role of the second layer 7. It is also achieved by PECVD at a deposition temperature less than or equal to 150° C. The final layer 10 has a mean thickness of about one micrometer.

In a second alternative embodiment, the first and second layers 7 and 8 can form a reiterating elementary stack, the protective envelope then comprising a superposition of at least two elementary stacks. Thus, in FIG. 4, the protective envelope comprises an alternation of two first layers 7 and two second layers 8. In an alternative embodiment represented in FIG. 5, the protective envelope comprises a superposition of two elementary stacks each comprising an intermediate layer 9 arranged between the first and second layers 7 and 8 of the elementary stack.

1-9. (canceled)

10. Lithium microbattery comprising a substrate on which at least one stack is arranged, said stack successively comprising a cathode, an electrolyte containing lithium and an anode made of metallic lithium, a protective envelope comprising at least first and second distinct superposed layers covering the stack to protect same against any external contamination, wherein:
the first layer, deposited on the whole of the anode, comprises at least one material that is chemically inert with regard to lithium and selected from the group consisting of a hydrogenated amorphous silicon carbide, a hydrogenated amorphous silicon oxycarbide, hydrogenated amorphous carbon, fluorinated amorphous carbon and hydrogenated amorphous silicon,
and the second layer comprises a material selected from the group consisting of a hydrogenated amorphous silicon carbonitride, a hydrogenated amorphous silicon nitride and a fluorinated amorphous carbon.

11. Microbattery according to claim 10, wherein an intermediate layer is arranged between the first and second layers, said intermediate layer comprising a material selected from the group consisting of a phosphorus-doped silicon oxide, hydrogenated amorphous carbon and fluorinated amorphous carbon.

12. Microbattery according to the claim 11, wherein the phosphorus doping in the phosphorus-doped silicon oxide is less than or equal to 10% in weight.

13. Microbattery according to claim 10, wherein the protective envelope comprises a superposition of at least two elementary stacks, each elementary stack being formed by first and second layers.

14. Microbattery according to claim 10, wherein the protective envelope is covered by a final layer of hydrogenated amorphous carbon or of fluorinated amorphous carbon.

15. Microbattery according to claim 10, wherein each layer has a thickness of about one micrometer.

16. Method for producing a lithium microbattery according to claim 10, consisting in successively depositing on a substrate:
at least one stack comprising a cathode, an electrolyte comprising lithium and an anode made of metallic lithium,
and a protective envelope comprising at least first and second distinct superposed layers covering the stack to protect same against external contamination,
wherein the first and second layers are successively deposited on the whole of the anode, by plasma enhanced chemical vapor deposition at a deposition temperature less than or equal to 150° C.

17. Method for producing a lithium microbattery according to claim 16, consisting in depositing an intermediate layer by plasma enhanced chemical vapor deposition, at a deposition temperature less than or equal to 150° C., before deposition of the second layer, said intermediate layer comprising a material selected from the group consisting of a phosphorus-doped silicon oxide, hydrogenated amorphous carbon and fluorinated amorphous carbon.

18. Method for producing a lithium microbattery according to claim 16, consisting in depositing a final layer of hydrogenated amorphous carbon or fluorinated amorphous carbon on the second layer by plasma enhanced chemical vapor deposition, at a deposition temperature less than or equal to 150° C.
